(19) United States
(12) Patent Application Publication
(10) Pub. No.: US 2024/0254787 A1
(43) Pub. Date: Aug. 1, 2024

(54) CONSTRUCTION METHOD FOR RENOVATION TO ADD DEDICATED ELEVATOR

(71) Applicant: Land Business Co., Ltd., Tokyo (JP)

(72) Inventor: Masamichi KAMEI, Tokyo (JP)

(21) Appl. No.: 18/554,659

(22) PCT Filed: Jul. 29, 2022
(86) PCT No.: PCT/JP2022/029222

§ 371 Date: Oct. 10, 2023

(30) Foreign Application Priority Data
Jul. 29, 2021 (JP) 2021-124138

(51) Int. Cl. E04G 23/02; E04H 1/04; E04H 3/02

(52) U.S. Cl. CPC E04G 23/02; E04H 1/04; E04H 3/02

(57) ABSTRACT

A construction method for renovation to add a dedicated elevator according to the present invention is used, in cases where a shop or a company located in a multistoried building equipped with an existing elevator owns the floors of a plurality of levels adjacent in the vertical direction, for instance, to add a dedicated elevator that interconnects only the floors or two or more levels adjacent in the vertical direction. The construction method includes: at a predetermined position in a portion finished as a floor slab of a floor serving as a dedicated part of the levels adjacent in the vertical direction, newly providing an opening in which an elevator shaft can be formed; constructing, in the opening, the elevator shaft passing through the floor or the floors of the plurality of levels and having an opening/closing door on each level; and installing, inside the elevator shaft, a cage for the elevator to be newly added and a lifting means for lifting the case up and down.

### TECHNICAL FIELD

This invention relates to a construction method for renovation to add a dedicated elevator that is to be used, separately from an existing elevator, for a shop that occupies the floors of two or more levels adjacent in the vertical direction, for instance, mainly in relation to a RC (Reinforced Concrete) or SRC (Steel Reinforced Concrete) or S (Steel-framed) structure multistoried building equipped with the existing elevator, such as a commercial building and an office building.

### BACKGROUND ARTS

For the RC or SRC or S structure multistoried building such as the commercial building and the office building, it is a matter of common knowledge that an elevator is installed as one facility in a common part. When designing the multistoried building, the elevator of this type is considered as a structure that is so important as to be indispensable from a structural point of view. Accordingly, planning for installation of the elevator is usually made at the beginning of the design of the building, and the elevator is seldom relocated or added after the completion of the building.

Meanwhile, it is true that there are a lot of cases where a shop or a company located in the multistoried building such as the commercial building and the office building occupies the floors of two or more levels adjacent in the vertical direction for the purpose of expansion of the shop or the company, for instance, and consequently, a dedicated elevator that is available only on the premises of the shop or between the floors of the levels that the same company occupies is considered desirable from the viewpoint of the improvements on business-related convenience and/or security.

In regards to the above cases, controlling some of a plurality of elevators in the common part has been heretofore in execution so as to allow users to get on and off the elevator only at predetermined specific floors, whereas it cannot be considered sufficient in the aspects of the business-related convenience and/or security, because of the fact that there are some problems such as the reduction in an entire utilization efficiency of the common part in terms of a way of making effective use of the common part, and that the elevator is supposed to be installed as one facility in the common part.

Moreover, as to a problem on the aging of its population as one social problem having become a hot topic recently, it is hoped that renovation to add a dedicated elevator will be performed to actualize the barrier-free accessibility for aged customers having difficulty in stepping up and down the stairs for movement inside the shop that exists over the floors of a plurality of levels.

Conventionally, in relation to one renovation to add an elevator to an existing building, a patent document 1 below, for instance, discloses a construction method for an elevator to be attached to an existing collective housing equipped with an external staircase leading to an entrance to each dwelling unit, with a landing located on the outside of a building body, wherein this construction method is used to attach an elevator to an existing building in such a way as to construct an elevator structure on the side of the external staircase of the existing collective housing, followed by connecting the elevator structure to a floor of each level of the existing collective housing through a newly constructed floor located on the same plane.

As one construction method for post-installing an elevator to an existing staircase-type collective housing, a patent document 2 below discloses a construction method for post-installing an elevator to an existing staircase-type collective housing, wherein this construction method comprises the following processes that are carried out in order: a process (A) of installing an elevator structure adjacent to a staircase, a process (B) of installing a temporary passage across the elevator structure and the collective housing, in a location on the top floor, a process (C) of removing the existing stairs on one side in the range from the top floor of the collective housing to a landing just below the top floor, a process (D) of installing a main passage across the elevator structure and the collective housing, in the location on the top floor, a process (E) of removing the temporary passage, a process (F) of newly installing the extended stairs, which are to be linearly connected to the existing stairs on the other side, sequentially from the upper floor to the lower floor, up to a landing floor surface of each level of the elevator structure and also to the landing just below the landing floor surface thereof, and a process (G) of installing the main passage across the elevator structure and the collective housing sequentially from the upper floor to the lower floor, in the location of the floors other than the top floor.

As one new elevator installation structure that allows a new elevator to be installed at low cost in a short period of time without any need to change a total floor area and a building area of an existing building, and also ensures that any effect of rainwater will be eliminated during a construction work, a patent document 3 below discloses a structure for installation of a new elevator to the inside of an existing building, wherein an opening is provided in a floor slab to place an elevator shaft in the opening and also to install an elevator pit that forms the foundation of a support for an elevator rail, separately from the foundation of the existing building, and the support for the elevator rail is connected to the existing building vertically movably relative to the existing building.

In relation to one reconstruction method a for multistoried building, a patent document 4 below discloses a building reconstruction method that allows a new elevator to be added, in addition to an existing elevator, in such a way that an elevator installation space passing through the floor of each level is preliminarily formed in a common part, without affecting a building part used for the conventional purposes, in cases where the building is partly subjected to changes in purpose of use, such as from a residence to a hotel, for instance.

### PRIOR ART DOCUMENTS

### Patent Documents

Patent document 1: Japanese Patent Publication No. 4070934
Patent document 2: Japanese Patent Publication No. 5946576
Patent document 3: Japanese Unexamined Patent Application Publication No. 2002-308547
Patent document 4: Japanese Unexamined Patent Application Publication No. 2003-184330

### SUMMARY OF THE INVENTION

### Problems to be Solved by the Invention

The inventions as disclosed in the above patent document 1 and 2 are aimed at constructing the elevator structure exclusive for an elevator at an external stair position of the collective housing, for instance, followed by connecting the elevator structure and the floor of each level of the existing collective housing through the newly constructed floor. Accordingly, although having the advantage that renovation to add the elevator can be attained without substantially affecting a building frame of collective housing body, these inventions require a high construction cost for the renovation to add the elevator, and are considered unsuitable for such renovation as to add a dedicated elevator that interconnects only the floors of two levels adjacent in the vertical direction or of several levels adjacent in the vertical direction.

The invention as disclosed in the above patent document 3 is not subject to the dedicated elevator, but is aimed at suppressing the effect of the newly installed elevator upon the existing building during the occurrence of earthquakes in such a way as to provide a structure in which the corners of the existing building and the elevator shaft are cut out, when installing the new elevator for the purpose of attainment of the barrier-free accessibility for the building such as the collective housing equipped with no existing elevator, for instance.

As described the above, all the inventions as disclosed in the above patent documents 1 to 3 are provided with the object of newly installing a common-use elevator to the existing building equipped with no elevator, and accordingly, cannot be considered as being aimed at improving the business-related convenience and/or security in such a way as to perform, in cases where a shop or a company located in the multistoried building such as the commercial building and the office building occupies the floors of two or more levels adjacent in the vertical direction, the renovation to add, separately from the existing elevator, the dedicated elevator that is limited to between the floors that the shop or the company occupies.

The invention as disclosed in the above patent document 4 is provided with the object of allowing machines and equipment for the elevator to be incorporated later into a space having been preliminarily formed as the elevator installation space since the initial stage of construction of the building, when the renovation to add the elevator has to be performed. For that reason, it is difficult to make effective use of the building until the renovation to add the elevator is complete, with the result that limitations will be rather imposed on the utilization of the building.

An object of the present invention is to provide a construction method for renovation to add a dedicated elevator, with which it is possible to improve the business-related convenience or security of a shop or a company that uses, separately from an existing common-use elevator, an elevator as a dedicated elevator that interconnects only the floors of two or more levels adjacent in the vertical direction, and also, the barrier-free accessibility is made realizable, with attainment of excellent economic property.

### Means for Solving the Problems

A construction method for renovation to add a dedicated elevator, which is used, in cases where a shop or a company located in a RC or SRC or S structure multistoried building equipped with an existing elevator owns or occupies, as a tenant, the floors of a plurality levels adjacent in the vertical direction, to add a dedicated elevator that interconnects only the floors of two or more levels adjacent in the vertical direction, wherein this construction method comprises: at a predetermined position in a portion finished as a floor slab of a floor serving as a dedicated part of the levels adjacent in the vertical direction, newly providing an opening in which an elevator shaft can be formed; constructing, around the opening, the elevator shaft passing through the floor or the floors of a plurality of levels and having an opening/closing door on each level; and installing, in the elevator shaft, a cage for the dedicated elevator and a lifting means for lifting the cage up and down.

As a general rope-type elevator in terms of the type of elevator, use can be made of an elevator facility having constituents such as the cage lifted up and down inside the elevator shaft, a balance weight, a hoisting machine, ropes, a guide rail, various controllers and a safety device, for instance, in which case, however, any limitations are not particularly imposed on a structural type and a driving power means of the elevator, for instance, and hence, it may be possible also to install a machine room-less elevator or a hydraulic elevator, for instance, in accordance with an elevator installation condition, without being limited to the rope-type elevator.

Further, unlike the elevator in a common part, which is normally moved in the vertical direction throughout the floors of all the levels in the multistoried building, the dedicated elevator in the present invention is an elevator that interconnects only the floors of several levels in the multistoried building, thereby providing a relatively compact elevator facility with a small scale.

The dedicated elevator added by the construction method of the present invention is aimed at interconnecting only the floors of two or more levels adjacent in the vertical direction, and is thus assumed to be mainly applicable to cases where the floors of two or more levels adjacent in the vertical direction are considered as a dedicated part that the same owner (a specific shop owner, for instance) or an owner belonging to a specific group (such as business operators and tenants that are operating a shopping mall, for instance) owns or occupies.

When a single shop occupies and uses the floors of the plurality of levels adjacent in the vertical direction such as the floors of two levels from the first floor to the second floor or of three levels from the first floor to the third floor or of three levels from the second floor to the fourth floor in the multistoried building, for instance, the renovation to add the dedicated elevator vertically passing through the dedicated part would result in that a barrier-free route of movement inside the shop is made realizable.

Meanwhile, the construction method for renovation to add the dedicated elevator according to the present invention is suitably applied to a multistoried building that is at least five-storied, as the multistoried building targeted for the renovation to add the dedicated elevator. While the scope of application of this construction method may differ depending on the number of floors of the levels of the building, it can be considered also that, when the same user occupies the floors of five levels in a multistoried building that is ten-storied, for instance, the number of floors of the levels to be interconnected by the dedicated elevator shall be set to be five.

It is to be noted that the renovation to add the dedicated elevator that interconnects only the floors of two levels adjacent in the vertical direction or of several levels adjacent in the vertical direction, in addition to the existing common-use elevator, can be more highly beneficial as the ratio of the floors (the number of floors of the levels) targeted for the dedicated elevator to be added or a floor area ratio is smaller, as compared with the number of floors of the levels of the whole building and the total floor area thereof.

### Effects of the Invention

In the cases where the shop or the company located in the multistoried building such as the commercial building and the office building occupies the floors of two or more levels adjacent in the vertical direction, for instance, the renovation to add, separately from the existing common-use elevator, the dedicated elevator that is limited to between the floors of the levels that the shop or the company occupies would result in that the business-related convenience and/or security can be improved.

Unlike the elevator in the common part, which is normally moved in the vertical direction throughout the floors of all the levels in the multistoried building, the dedicated elevator in the present invention is the elevator that interconnects only the floors of several levels in the multistoried building, thereby providing the relatively compact elevator facility with the small scale, with the result that the elevator construction cost and/or the cost of the elevator facility itself can be suppressed.

### BRIEF DESCRIPTION OF THE DRAWINGS

FIG. 1 shows a first-floor part in accordance with one embodiment of a construction method for renovation to add a dedicated elevator in the present invention, FIG. 1(a) being a plan view of the first-floor part before renovation, and FIG. 1(b) being a plan view of the first-floor part after renovation.

FIG. 2 shows a second-floor part in accordance with the embodiment shown in FIG. 1, FIG. 2(a) being a plan view of the second-floor part before renovation, and FIG. 2(b) being a plan view of the second-floor part after renovation.

FIG. 3 is a vertical cross-sectional view (with a different contraction scale) in accordance with the embodiment shown in FIG. 1, FIG. 3(a) being a vertical cross-sectional view before renovation, FIG. 3b being a vertical cross-sectional view after renovation, and FIG. 3(c) being a vertical cross-sectional view showing another embodiment of the present invention after renovation.

### MODE FOR EMBODYING THE INVENTION

Hereinafter will be described the present invention with reference to the attached drawings.

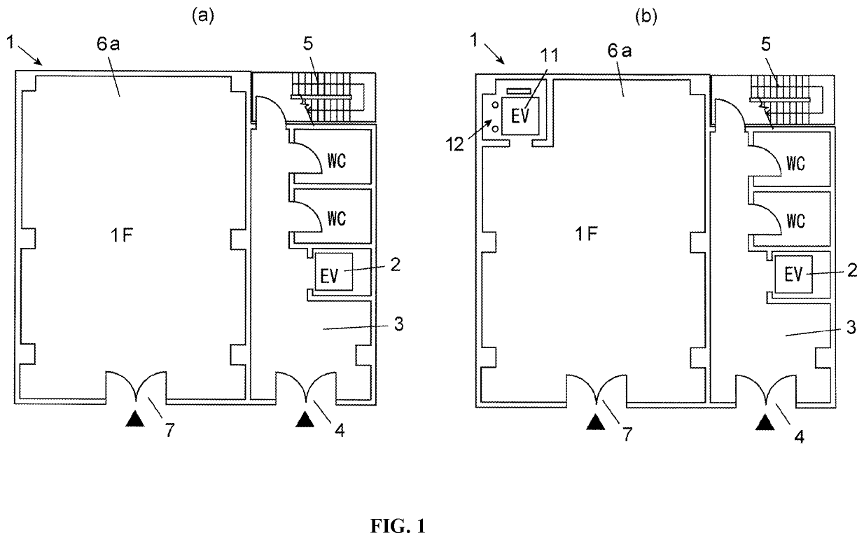

FIGS. 1 to 3 respectively show one embodiment of a construction method for renovation to add a dedicated elevator according to the present invention.

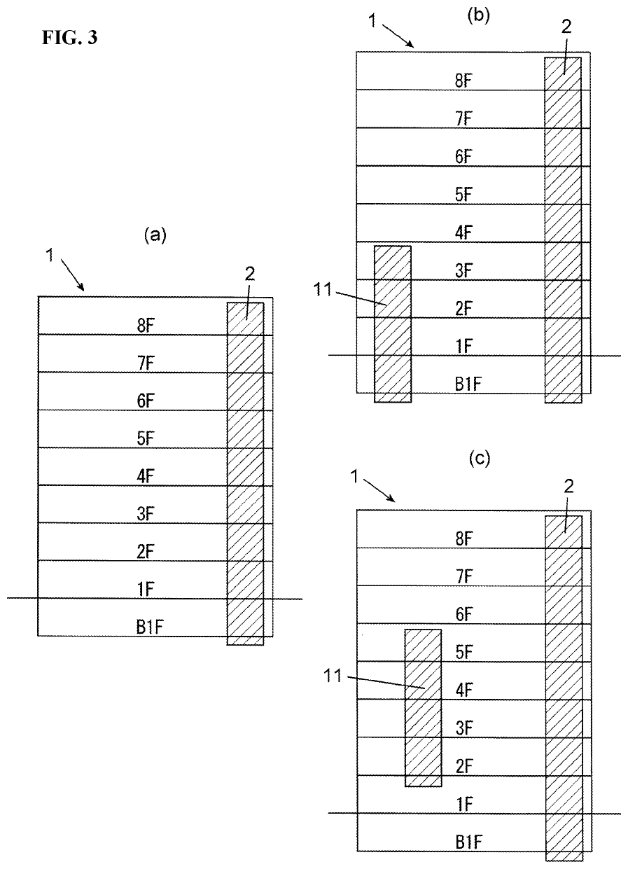

This embodiment is such that, in relation to a RC or SRC or S structure multistoried building 1 that is eight-storied and equipped with an existing common-use elevator 2 as shown in FIG. 3(a), for instance, a new dedicated elevator 11 is added as shown in FIG. 3(b) or FIG. 3(c), as one renovation of the building 1.

FIG. 3(b) shows one embodiment when the dedicated elevator 11 is added as extending over the floors of four levels from the first basement to the third floor of the building 1, and FIG. 3(c) shows another embodiment when the dedicated elevator 11 is added as extending over the floors of four levels from the second floor to the fifth floor of the building 1.

In cases where a shop or a company owns or occupies, as a tenant, the floors of a plurality of levels adjacent in the vertical direction, for instance, the dedicated elevator 11 is assumed to be an elevator that is added as the dedicated elevator 11 extending over the floors of the plurality of levels. In addition to the above, there can be other variations in correspondence to the floors of the levels that the shop or the company occupies, such as to add the dedicated elevator that interconnects only the floors of two levels from the first floor to the second floor or of three levels from the first floor to the third floor or of four levels from the fifth floor to the eighth floor, for instance.

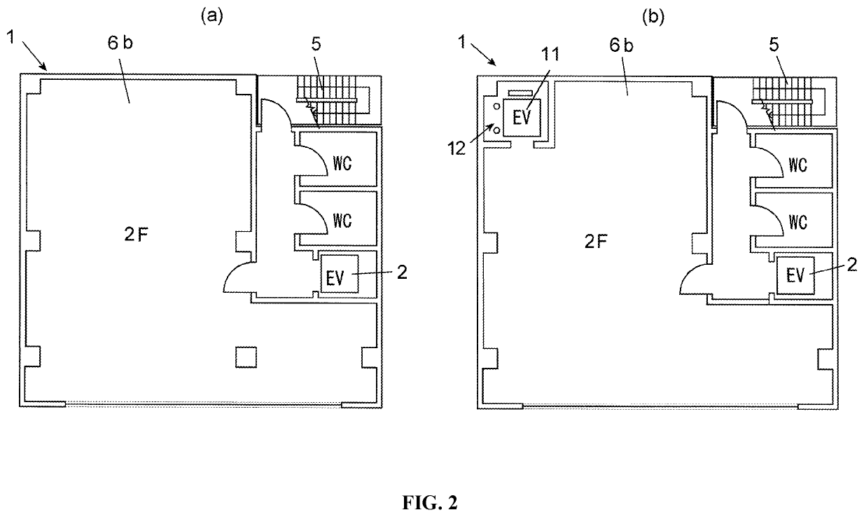

In terms of a planar arrangement, FIG. 1(a) shows a first-floor part before renovation, FIG. 1(b) shows the first-floor part after renovation, FIG. 2(a) shows a second-floor part before renovation, and FIG. 2(b) shows the second-floor part after renovation. In FIGS. 1 and 2, reference numeral 3 represents an entrance hall in a common part on the first floor, reference numeral 4 is an entrance to the entrance hall 3 in the common part on the first floor, reference numeral 5 is a staircase in the common part, and reference numeral 7 is an entrance to a dedicated part 6a of the shop on the first floor.

For this embodiment, it is to be noted that the same shop or the same company, for instance, is assumed to occupy the floors of four levels from the first basement to the third floor as shown in FIG. 3(b) or from the second floor to the fifth floor as shown in FIG. 3(c) (although not shown by a plan view), inclusive of the dedicated parts 6a, 6b of the shop as shown in FIGS. 1 and 2.

As shown in FIGS. 1 and 2, an opening in which an elevator shaft can be formed is provided at a top left-hand corner position (in FIGS. 1 and 2) in a floor slab portion that forms a dedicated part floor before renovation, an elevator shaft 12 passing through the floors of a plurality of levels and having an opening/closing door on each level is constructed around the opening, and a cage for the dedicated elevator 11 and a lifting means for lifting the cage up and down are installed inside the elevator shaft 12.

Accordingly, it can be appreciated that, in cases where a specific shop occupies the floors or two or more levels adjacent in the vertical direction, for instance, the renovation to add, separately from the existing common-use elevator 2, the dedicated elevator 11 that is limited to between the floors of the levels that the shop occupies, for instance, would result in that the business-related convenience or security can be improved and also that a barrier-free space can be provided for the aged customers who visit the shop, for instance.

### EXPLANATION OF REFERENCE NUMERALS

1 . . . Multistoried building, 2 . . . Common-use elevator (Existing elevator), 3 . . . Entrance hall (Common part), 4 . . . Entrance (Common part), 5 . . . Staircase (Common part), 6a, 6b . . . Dedicated part of shop, 7 . . . Entrance (Dedicated part), 11 . . . Dedicated elevator (Added), 12 . . . Elevator shaft (Added)

1. A construction method for renovation to add a dedicated elevator, in cases where a shop or a company located in a RC or SRC or S structure multistoried building equipped with an existing elevator owns or occupies, as a tenant, the floors of a plurality of levels adjacent in the vertical direction, to add said dedicated elevator that interconnects only the floors of two or more levels adjacent in the vertical direction, said construction method comprising the steps of:
at a predetermined position in a portion finished as a floor slab of a floor serving as a dedicated part of the levels adjacent in the vertical direction, newly providing an opening in which an elevator shaft can be formed;
constructing, around said opening, the elevator shaft passing through the floor or the floors of the plurality of levels and having an opening/closing door on each level; and
installing, inside said elevator shaft, a cage for the dedicated elevator and a lifting means for lifting said cage up and down.

2. The construction method for renovation to add the dedicated elevator according to claim 1, wherein the multistoried building targeted for renovation to add the dedicated elevator is a multistoried building that is at least five-storied.
